(19) United States
(12) Patent Application Publication
(10) Pub. No.: US 2006/0271383 A1
(43) Pub. Date: Nov. 30, 2006

(54) Entity synchronization using filtering

(75) Inventors: Ryan A. Munson, Fargo, ND (US); Jeffrey R. Anderson, West Fargo, ND (US); John A. Healy, West Fargo, ND (US); Josh W. Honeyman, Bellevue, WA (US)

Correspondence Address: WESTMAN CHAMPLIN (MICROSOFT CORPORATION), SUITE 1400, 900 SECOND AVENUE SOUTH, MINNEAPOLIS, MN, 55402-3319, US

(73) Assignee: Microsoft Corporation, Redmond, WA (US)

(21) Appl. No.: 11/139,834

(22) Filed: May 27, 2005

(51) Int. Cl. G06Q 99/00

(52) U.S. Cl. 705/1

(57) ABSTRACT

The present invention provides a filtering mechanism for filtering data synchronized from an entity in an owning service to a consumer. The filtering mechanism can include one or more of temporal filtering, filtering based on security permissions, filtering based on organization structure or roles, and user-defined filters. Different and additional filters can be used as well.

### BACKGROUND OF THE INVENTION

The present invention deals with entities in service oriented systems. More specifically, the present invention deals with the filtering of data synchronized from an owning service to a consumer (which may also be a service) in a service oriented system.

A service is a system that a consumer of the service (such as a client or another service) interacts with through a set of coarse-grained messages. A service oriented application may be composed of one or more services. Each of these application services typically contain a set of entities. Entities, in general, encapsulate data and provide a rich programming model for reading, writing, updating and deleting the data owned by the service.

Services typically contain private data and public data. The private data is encapsulated in an internal entity so that, within the service, the programming model provides access to all of the data and associations contained in the internal entity, but external to the service, the internal entity is not exposed through the service interface. However, public data is encapsulated in a publicly available entity which is available to consumers of the service.

It is common for a consumer of a service to access data of an entity owned by the service. One prior way for enabling this had the consumer directly access the owning service's data store. However, a direct access to the owning service's data store requires the consumer of the data to have knowledge of the technology and table structure used by the owning service to store data in its data store. Similarly, such a direct access allows the consumer to potentially view and change private data within the service.

This is problematic for a number of reasons, and is not allowed in applications that honor the publicly known tenets of service orientation. These are set out in an article by Don Box entitled Code Name Indigo: A Guide to Developing and Running Connected Systems with Indigo, MSDN Magazine, January 2004. Basically, allowing an external service or client to bind directly to the owning service's data (either by access to the service's private entities or by directly accessing the database which the service stores its data in) is a technique that compromises data integrity, the autonomy, and the explicit boundaries of a service, in a service oriented environment. Instead, all communication with a service should use standardized message exchange.

In addition, many developers wish to develop systems in which the services are autonomous. Synchronizing and replicating data locally to the consumers of the service is often done to achieve such autonomy, because a given consumer does not then require the owning service to be available to retrieve data and process requests. However, a consumer may only be interested in a subset of the properties of the entity in the owning service. In the past, in order to access only part of an entity, the consumer was required to have table-level access to the data in the owning service (which violates the tenets of service orientation as mentioned above), or it had to request the entire entity through the owning service's interface. Of course, an entity may have a very large number of properties (often in the hundreds) and a consumer may only require access to a very small number (such as five) of the properties. The consumer will normally not wish to incur all the overhead for processing such a large data set, when it only needs a small subset of the data.

This becomes even more important if functionality is provided to synchronize associated data to a local data store. For instance, a consumer may wish to periodically synchronize a subset of the data from the owning service's data store to its own local data store. The consumer's local data store may be remote from the owning service's data store and may even be on a laptop computer or other mobile device. If the consumer is required to synchronize unwanted properties of an entity, this can greatly increase the amount of time and processing overhead required to perform the synchronization process. Further, when bringing a consumer on line, the initial synchronization of data can become burdensome and consume undesirable amounts of time and processing overhead.

Services also typically expose a plurality of publicly available data contracts. The data contracts identify the publicly available entities and the properties contained within those entities and specify how the entities are associated or related. Upon being queried through an interface, the service will generally provide access to the data in the publicly available data contracts to the requestor.

### SUMMARY OF THE INVENTION

The present invention provides a filtering mechanism for filtering structured data exposed through a service-oriented interface and synchronized from an owning service to a consumer. The filtering mechanism can include one or more of temporal filtering, filtering based on security permissions, filtering based on organization structure or roles, and user-defined filters. Different and additional filters can be used as well.

### BRIEF DESCRIPTION OF THE DRAWINGS

FIG. 1 is a block diagram of one computing environment in which the present invention may be practiced.

FIG. 2 is a block diagram of two services, each with entities and public data contracts.

FIG. 3A illustrates a generation tool used for generating entity projections in accordance with one embodiment of the present invention.

FIG. 3B illustrates the tools shown in FIG. 3A interacting with additional services.

FIG. 4 shows a more detailed embodiment of two services, their corresponding entities, and entity projections.

FIG. 5 is a block diagram illustrating how filters are applied to data that is synchronized from an aggregation component to a requestor.

FIG. 6 is a flow diagram illustrating the operation of the system shown in FIG. 5.

### DETAILED DESCRIPTION OF ILLUSTRATIVE EMBODIMENTS

The present invention deals with filtering structured data that is replicated from an owning service to one or more consumers of that data. The consumer may illustratively be a client, or another service. However, before describing the present invention in greater detail, one illustrative environment in which the present invention can be used will be described.

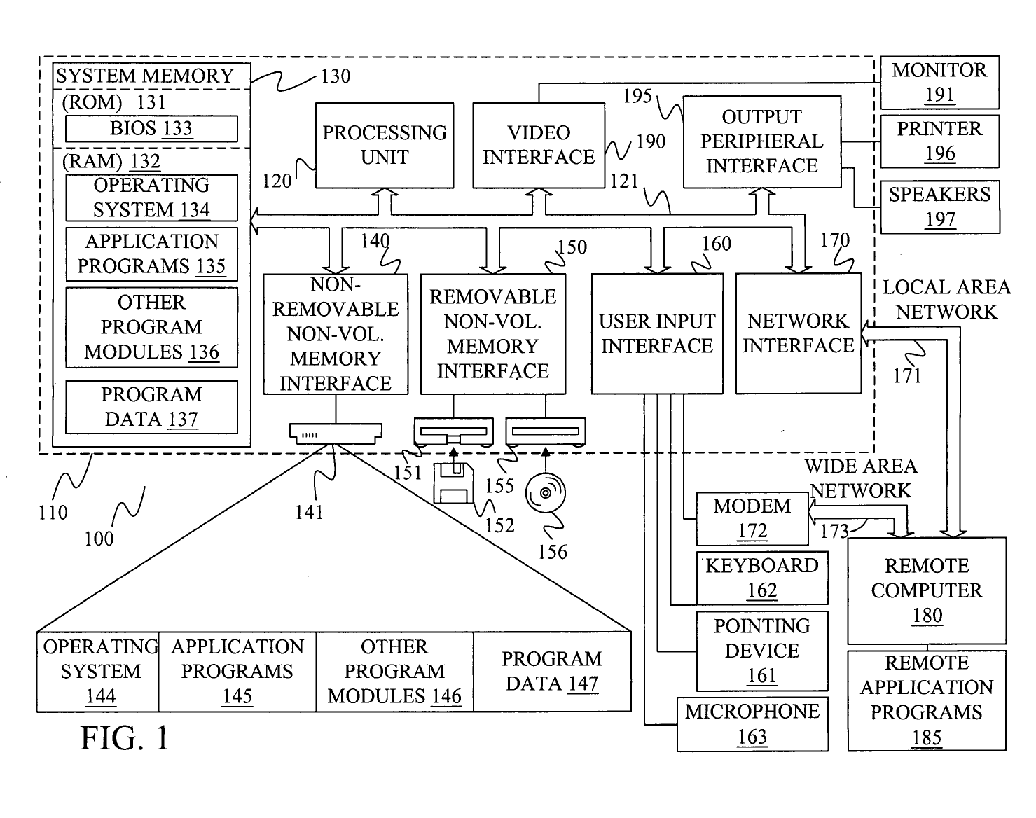

FIG. 1 illustrates an example of a suitable computing system environment 100 on which the invention may be implemented. The computing system environment 100 is only one example of a suitable computing environment and is not intended to suggest any limitation as to the scope of use or functionality of the invention. Neither should the computing environment 100 be interpreted as having any dependency or requirement relating to any one or combination of components illustrated in the exemplary operating environment 100.

The invention is operational with numerous other general purpose or special purpose computing system environments or configurations. Examples of well-known computing systems, environments, and/or configurations that may be suitable for use with the invention include, but are not limited to, personal computers, server computers, hand-held or laptop devices, multiprocessor systems, microprocessor-based systems, set top boxes, programmable consumer electronics, network PCs, minicomputers, mainframe computers, telephony systems, distributed computing environments that include any of the above systems or devices, and the like.

The invention may be described in the general context of computer-executable instructions, such as program modules, being executed by a computer. Generally, program modules include routines, programs, objects, components, data structures, etc. that perform particular tasks or implement particular abstract data types. The invention is designed to be practiced in distributed computing environments where tasks are performed by remote processing devices that are linked through a communications network. In a distributed computing environment, program modules are located in both local and remote computer storage media including memory storage devices.

With reference to FIG. 1, an exemplary system for implementing the invention includes a general-purpose computing device in the form of a computer 110. Components of computer 110 may include, but are not limited to, a processing unit 120, a system memory 130, and a system bus 121 that couples various system components including the system memory to the processing unit 120. The system bus 121 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

Computer 110 typically includes a variety of computer readable media. Computer readable media can be any available media that can be accessed by computer 110 and includes both volatile and nonvolatile media, removable and non-removable media. By way of example, and not limitation, computer readable media may comprise computer storage media and communication media. Computer storage media includes both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computer 110. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer readable media.

The system memory 130 includes computer storage media in the form of volatile and/or nonvolatile memory such as read only memory (ROM) 131 and random access memory (RAM) 132. A basic input/output system 133 (BIOS), containing the basic routines that help to transfer information between elements within computer 110, such as during start-up, is typically stored in ROM 131. RAM 132 typically contains data and/or program modules that are immediately accessible to and/or presently being operated on by processing unit 120. By way of example, and not limitation, FIG. 1 illustrates operating system 134, application programs 135, other program modules 136, and program data 137.

The computer 110 may also include other removable/non-removable volatile/nonvolatile computer storage media. By way of example only, FIG. 1 illustrates a hard disk drive 141 that reads from or writes to non-removable, nonvolatile magnetic media, a magnetic disk drive 151 that reads from or writes to a removable, nonvolatile magnetic disk 152, and an optical disk drive 155 that reads from or writes to a removable, nonvolatile optical disk 156 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 141 is typically connected to the system bus 121 through a non-removable memory interface such as interface 140, and magnetic disk drive 151 and optical disk drive 155 are typically connected to the system bus 121 by a removable memory interface, such as interface 150.

The drives and their associated computer storage media discussed above and illustrated in FIG. 1, provide storage of computer readable instructions, data structures, program modules and other data for the computer 110. In FIG. 1, for example, hard disk drive 141 is illustrated as storing operating system 144, application programs 145, other program modules 146, and program data 147. Note that these components can either be the same as or different from operating system 134, application programs 135, other program modules 136, and program data 137. Operating system 144, application programs 145, other program modules 146, and program data 147 are given different numbers here to illustrate that, at a minimum, they are different copies.

A user may enter commands and information into the computer 110 through input devices such as a keyboard 162, a microphone 163, and a pointing device 161, such as a mouse, trackball or touch pad. Other input devices (not shown) may include a joystick, game pad, satellite dish, scanner, or the like. These and other input devices are often connected to the processing unit 120 through a user input interface 160 that is coupled to the system bus, but may be connected by other interface and bus structures, such as a parallel port, game port or a universal serial bus (USB). A monitor 191 or other type of display device is also connected to the system bus 121 via an interface, such as a video interface 190. In addition to the monitor, computers may also include other peripheral output devices such as speakers 197 and printer 196, which may be connected through an output peripheral interface 195.

The computer 110 is operated in a networked environment using logical connections to one or more remote computers, such as a remote computer 180. The remote computer 180 may be a personal computer, a hand-held device, a server, a router, a network PC, a peer device or other common network node, and typically includes many or all of the elements described above relative to the computer 110. The logical connections depicted in FIG. 1 include a local area network (LAN) 171 and a wide area network (WAN) 173, but may also include other networks. Such networking environments are commonplace in offices, enterprise-wide computer networks, intranets and the Internet.

When used in a LAN networking environment, the computer 110 is connected to the LAN 171 through a network interface or adapter 170. When used in a WAN networking environment, the computer 110 typically includes a modem 172 or other means for establishing communications over the WAN 173, such as the Internet. The modem 172, which may be internal or external, may be connected to the system bus 121 via the user input interface 160, or other appropriate mechanism. In a networked environment, program modules depicted relative to the computer 110, or portions thereof, may be stored in the remote memory storage device. By way of example, and not limitation, FIG. 1 illustrates remote application programs 185 as residing on remote computer 180. It will be appreciated that the network connections shown are exemplary and other means of establishing a communications link between the computers may be used.

The present discussion proceeds with respect to an exemplary embodiment in which the filtering mechanism of the present invention is applied to data synchronized to a consumer from an owning service. Specifically, the embodiment discusses synchronizing data accessed through an entity projection. However, the present invention is not limited to this exemplary embodiment, since the filtering mechanism is new whether synchronizing data accessed through an entity or an entity projection.

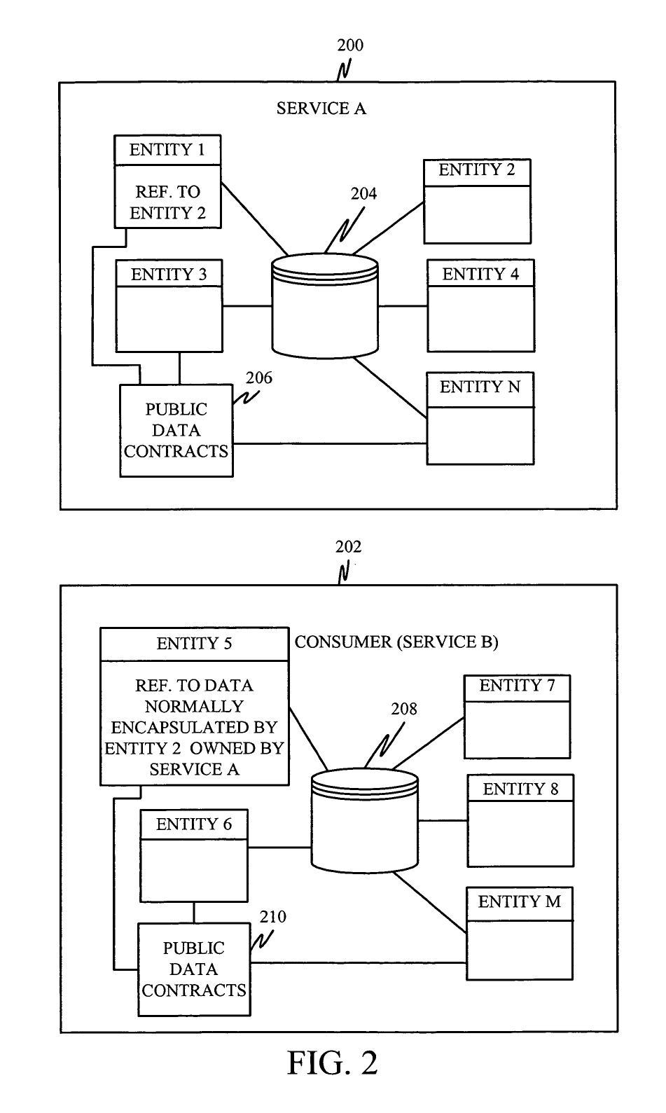

FIG. 2 is a block diagram of two autonomous services, service A represented by numeral 200 and service B represented by numeral 202. Service A is shown with a plurality of entities (entity 1-entity N) that are stored in a data store 204 that is local to service A. FIG. 2 also shows that service A includes one or more public data contracts 206 that represent the entities, how they are related, and the properties in each of those entities. There may illustratively be one data contract per root entity. However, the data contracts could be arranged in other ways as well.

Service B also includes a plurality of entities (entity 5-entity M) that are stored in a data store 208 that is local to service B. FIG. 2 also shows that service B includes one or more public data contracts 210 that describe the entities, the relationships between the entities, and the properties for the entities found in service B. For the sake of the present discussion, service B is referred to as the consumer 202. That is because service B includes an entity (entity 5) that has a reference to a record (or consumes information) owned by service A. For instance, entity 5 in service B might consume data encapsulated by entity 2 which is owned by service A. Therefore, service B is designated as the consumer 202 because it consumes data owned by another service. It will of course be noted that by consumer it is meant a service, application, entity, or other component that requires access to data in another service.

In prior systems, in order for service B to access the data in service A, a number of different techniques could be used. In a first technique, service B would require direct association to the entity in service A and/or the data stored in data store 204 in service A. This would lead to a number of problems which are discussed in the background portion of this description. Alternatively, service B, could query service A for entity 2. Even though service B was only interested in a subset of the properties of entity 2 in service A, they would receive all properties. This also leads to disadvantages described in the background.

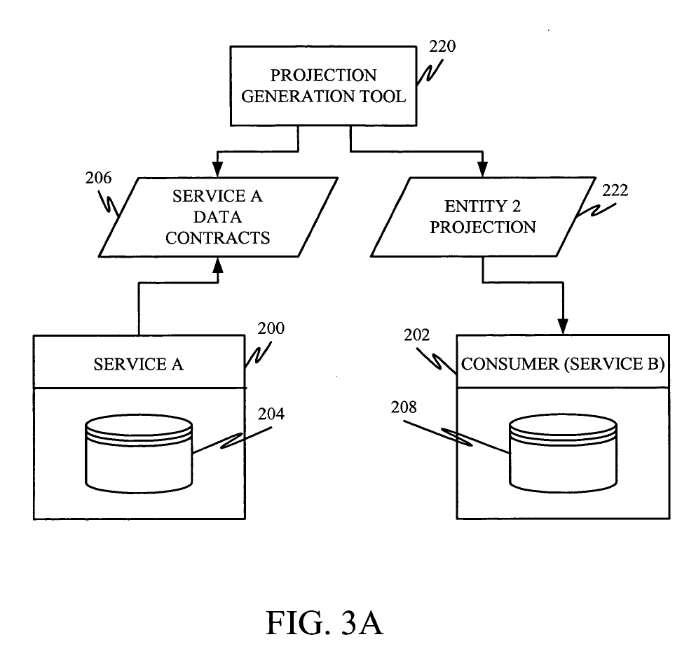

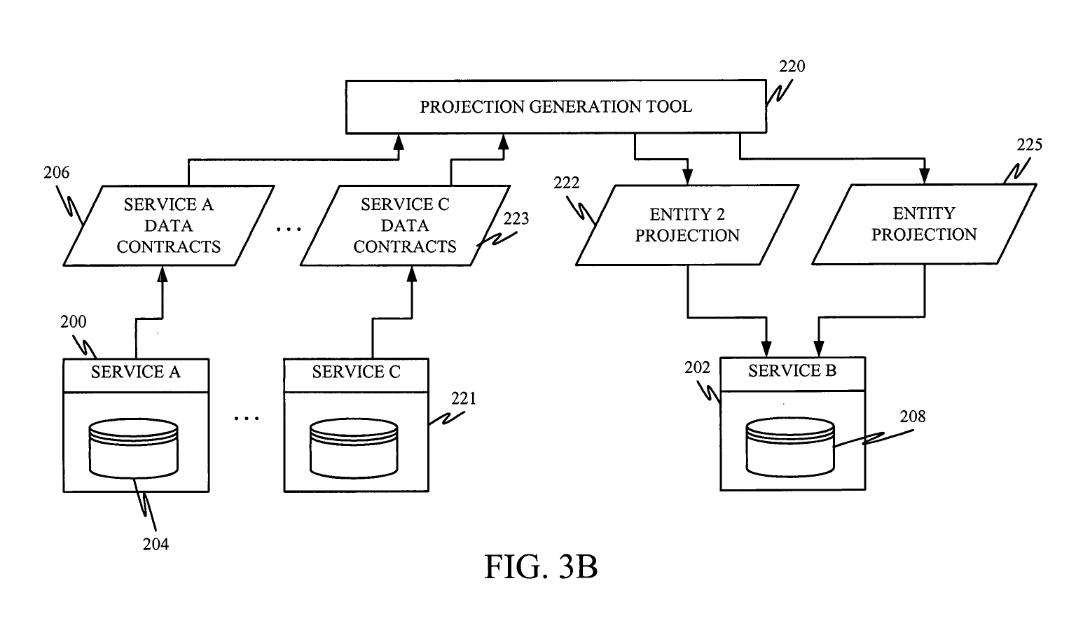

FIG. 3A shows one way of dealing with this problem, in which a projection generation tool 220 accesses the public data contract 206 from service A and creates an entity projection 222, from the information stored in contract 206, and provides entity projection 222 to service B. The description of tool 220 is but one embodiment for generating a projection. The entity projection 222 will illustratively fit the entity programming model in service B, but contain only the properties of entity 2 (from service A) that are required, and those that are desired by entity 5 in service B.

Tool 220 is illustratively configured to interact with services A and B through predetermined interfaces. In order to generate a projection, the present discussion will proceed with respect to entity 5 in service B requiring access to certain properties of entity 2 from service A. Therefore, tool 220 will generate an entity projection in service B of entity 2 from service A. Tool 220 initially queries service A for its public data contracts. Service A provides its data contracts 206 to tool 220, and tool 220 loads the data contracts.

Tool 220 then generates a class containing only the required properties based on the information set out in the publicly available data contract 206. The generated class corresponds to the projection class for which the projection is to be generated. The user can populate the generated entity in any desired way, such as using drag and drop operations.

The entity projection is thus a read-only entity abstraction that can be generated from the data contract for an entity exposed by another service. The projection can include any number of properties exposed from the owning entity's contract, but will illustratively also contain the required fields of the entity. The entity projections provide read functionality as does any other entity, but can be totally generated based on the data contract of another entity.

It will also be noted that projections can be generated from multiple different services, and compositions and associations can also be generated. For instance, FIG. 3B shows projection generation tool 220 generating entity projections for a consumer (service B) from not just a single service A, but from multiple services (service A and service C). The items that are similar to those shown in FIG. 3A are similarly numbered.

Service C shown in FIG. 3B is illustrated by numeral 221 and its publicly available data contracts are indicated by numeral 223. The entity projection from service C is indicated by numeral 225. Thus, service C makes its data contracts available to projection generation tool 220 which displays the publicly available properties in each data contract to the user. The user can then populate the generated entity classes as desired.

It may also happen that one of the displayed properties desired by the user may be an associated entity. In that case, tool 220 generates a class for the associated entity projection and populates it with the minimum property set. The user can select other properties for that projection as well. This can happen recursively, since associated entities can have association to other entities.

Once all of the desired generated class projections have been populated with properties from the user, the tool simply builds the projection entities and deploys them to the requesting service, in this case service B. Service B then stores the projections in its local data store 208. Building and deploying the projections can be performed at runtime, or otherwise, as desired.

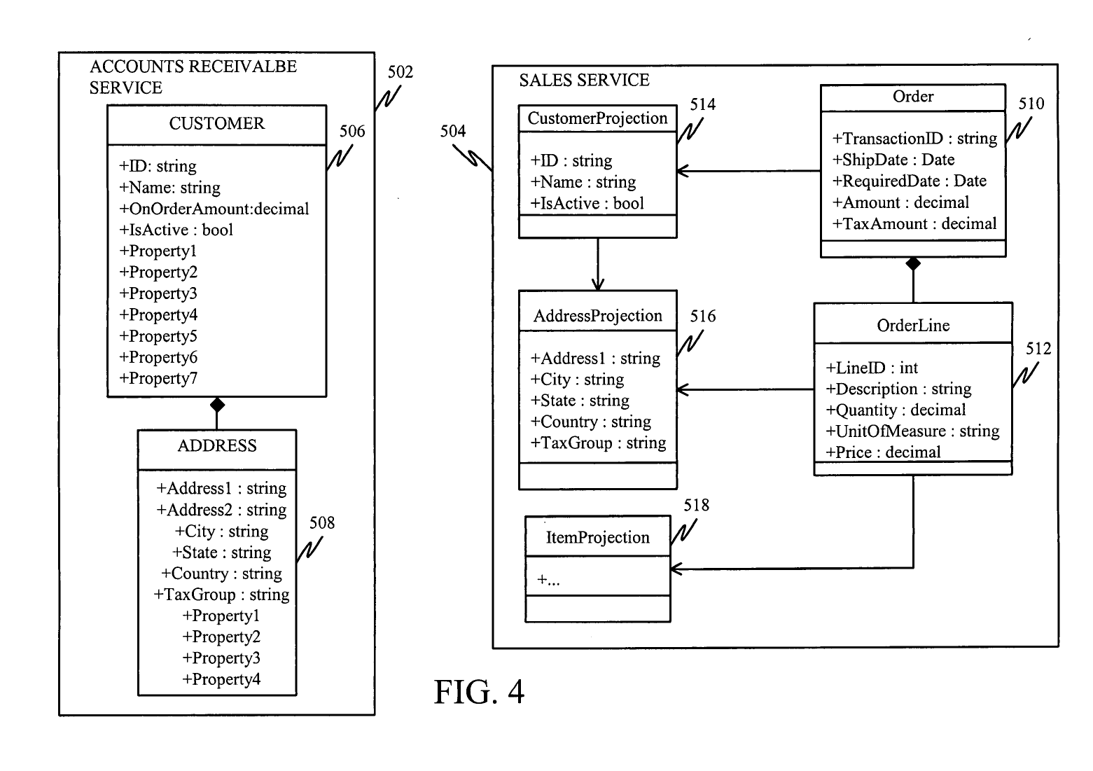

FIG. 4 illustrates a more concrete embodiment of an entity projection. FIG. 4 shows accounts receivable service 502 and sales service 504. Accounts receivable service 502 has a plurality of entities represented by a UML diagram. Accounts receivable service 502 includes a customer entity 506 that has a composition of addresses represented by address entity 508. Customer entity 506 is shown with a plurality of properties that represent a customer. Of course, in an actual application, there may be a very large number of properties, perhaps in excess of 100 properties in a customer entity 506. Address entity 508 is associated with customer entity 506 and is also shown with a plurality of properties, but may in actuality have as many as 50 or more properties.

Sales service 504 is also shown with a plurality of entities represented in a UML diagram. Sales service 504 includes order entities 510 and associated order line entities 512. It can be seen from the UML diagram that order entity 510 in sales service 504 requires a reference to the customer entities 506 in accounts receivable service 502. However, instead of directly referencing those entities in accounts receivable service 502, customer projection 514 has been created. Only the properties desired by sales service 504 are populated into projection 514. Therefore, order entity 510 in sales service 504 references the customer projection 514 which is also local to the sales service 504.

FIG. 4 also shows that order line entity 512 has an association of addresses. However, instead of directly referencing address entities 508 in accounts receivable services 502, address projection 516 is provided in sales service 504. Both projections 514 and 516 are stored on the data store locally used by sales service 504. Therefore, projections 514 and 516 conform to the entity programming model set up in sales service 504 and look as if they are locally owned entities, even though they are actually owned by a separate service.

FIG. 4 also shows that order line entity 512 has an associated item projection 518. In one illustrative embodiment, item projection 518 is an entity projection that comes from a service different from projections 514 and 516, which come from accounts receivable service 502. In an illustrative embodiment, projection 518 comes from an inventory service, for example.

It will be noted that the entities and projection entities shown and discussed as is generally known, have functionality that enables them to load and persist information from a database, and they are not simply object classes with a few properties. Instead, as is known, entities are much richer.

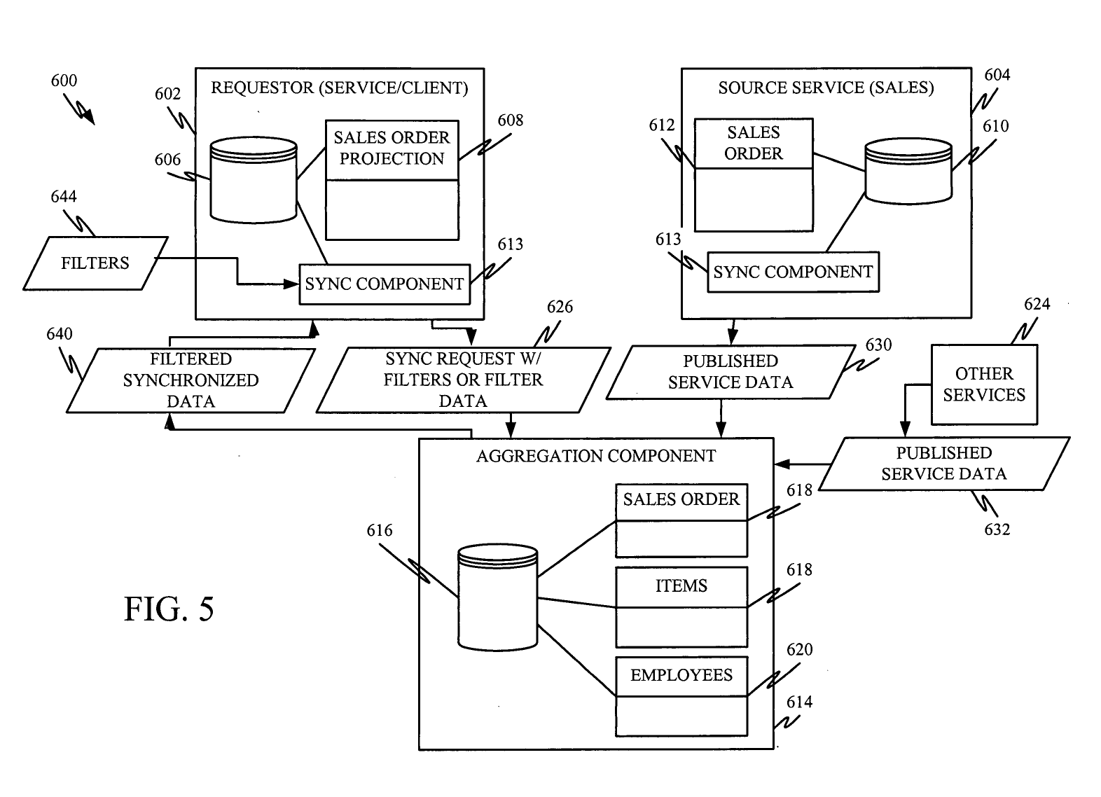

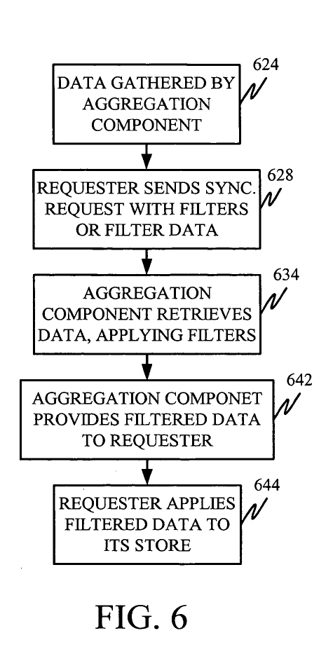

Once the entity projections are created as discussed above, they can be used as a programming construct to access data synchronized to the data store associated with the consumer (such as data store 208 in FIG. 3B). The data store 208 must first be populated with this data, and then changes, additions or deletions to that data must be synchronized to data store 208 in service B as well. As discussed with respect to FIGS. 5 and 6 below, it may be desirable to provide a filtering mechanism during initial population and synchronization. Again, the filtering mechanism of the present invention is not to be limited to filtering data synchronized to the data store and accessed through entity projections, but can also be used to filter data accessed through entities as well. It is described here in the context of an entity projection for the sake of example only.

FIG. 5 shows a system 600 that illustrates how filters are applied to data during initial population and synchronization in accordance with one embodiment of the present invention. FIG. 6 is a flow diagram illustrating the operation of system 600 in more detail.

System 600 includes a requester 602 which may be a service or another client. System 600 also includes an owning service 604, such as a sales service that deals with processing sales orders and the like. Requestor 602 includes a local data store 606 that contains entities, and possibly entity projections. FIG. 5 shows that requestor 602 includes a sales order entity projection 608. Owning service 604 also includes a data store 610 that contains entities and possibly entity projections. FIG. 5 shows that service 604 owns sales order entities 612 and thus they are stored on data store 610. It can thus be seen that client 602 needs access to a synchronized copy of the data in sales order entities 612 stored on owning service 604.

In order to obtain this access, a subset of the data from sales order entity 612 is synchronized to requestor 602 through aggregation component 614. Therefore, each of the requesters and services in system 600 illustratively include a synchronization (sync) component 613. Synchronization components 613 interact with aggregation component 614 to perform the steps necessary to transmit synchronization requests from requesters to aggregation component 614 and to handle returned data from aggregation component 614 in response to synchronization requests. The specific way the synchronization components 613 operate is not important for purposes of the present invention, other than to say that they are configured to handle the transmission of requests, filters (or data from which filters can be discerned), and the receipt of information in response to those requests.

Aggregation component 614, itself, includes an internal data store 616 that contains information from a wide variety of different owning services, which is to be synchronized to various consumers. In the embodiment shown in FIG. 5, data store 616 includes sales order entities 618 owned by sales service 604, item entities 620 which might be, for instance, owned by an inventory service, and employee entities 622 which might be, for example, owned by a human resources service. The various services not specifically identified, from which aggregation component 614 can receive data is represented by other services 624.

In order for aggregation component 614 to provide data to any given consumer, the consumer first illustratively registers with aggregation component 614 to obtain creates, updates, and deletes of certain data. The particular way in which this registration occurs is not important for the sake of the present invention.

In operation, aggregation component 614 gathers, and provides an aggregated view of, all the information published, from the various services 604 and 624 (and from requestor 602 if it is a service) and stores that information in data store 616. This is indicated by block 624 in FIG. 6. The published data from the various services 604 and 624 is indicated by numerals 630 and 632, respectively. Requestor 602 then illustratively sends a synchronization request 626, along with certain filters, or other data which can be used to discern or create filters, to aggregation component 614. This is indicated by block 628 in FIG. 6.

In response, aggregation component 614 retrieves the requested data from data store 616, applying the filters which were either passed along with the synchronization request 626 or which were discerned or generated based on information passed to aggregation component 614. This is indicated by block 634 in FIG. 6.

The filters may be desired for a number of reasons. If no filtering were applied to the synchronization requests, the synchronization operation may result in undesirable performance. For instance, assume that requester 602 is a laptop computer (or other computing device) used by a salesperson for a company. That specific salesperson may request synchronization of the sales order entities 618 from aggregation component 614. While the synchronization request will only be filled by supplying requestor 602 with the desired subset of properties and required properties for the sales order entities 618, aggregation component 614 will still provide that data for every single customer in data store 616, unless certain filtering is used.

This is undesirable for a number of reasons. For example, the user of requester 602 may have synchronized only a short time before the present synchronization request is made. In that case, many of the sales order entities 618 will be exactly the same (they will not yet have been updated) as when the previous synchronization was made. Thus, without some type of temporal filtering, a great deal of extra overhead and time will be required to synchronize data that has already been synchronized and is still valid.

In addition, there may well be some sales order entities 618 which the particular user of requestor 602 is not to have access to, for security reasons. Similarly, there may be some properties of sales order entities 618 which the user of requester 602 is prohibited from receiving, again for security or confidentiality reasons.

Further, the user may only need access to certain sales order entities 618 based on his or her role. For example, if the user of requester 602 works in accounts receivable, that user may only need access to sales orders for which payment is overdue. Further, the user himself, or herself, may only be interested in certain sales orders, such as those sales orders generated by that user, or generated in a sales territory for that user, or generated for a specific customer.

In addition, users may not be given access to certain information, such as human resources records of other people. The users should not be allowed to synchronize information they do not have access to.

Thus, the user and developer may wish to define some filtering mechanism to obtain, or provide access to, only desired information from data store 616. As described below, filters 644 can be implemented in the system by a developer (such as with both mandatory and optional filters) or they can be input by the user (as with user-selected or user-defined filters). Table 1 illustrates just a small sample of the types of filters which can be applied in accordance with one embodiment of the present invention.

TABLE 1

```
TIME STAMP
SECURITY
  EMPLOYEE
  ORG. STR.
ROLE
USER-DEFINED
```

The time stamp filter indicates a type of temporal filtering which will filter the returned data to contain only data that has been updated since the last synchronization request for that data. For instance, if the requester 602 synchronized sales orders at noon yesterday, and makes another synchronization request for sales orders, the only data returned in response to the request are those sales orders added, updated, or deleted since noon yesterday. The filter can be a time stamp of the last synchronization or other temporal information from which the filter can be discerned or created.

The security filter indicates that filters can be applied based on the identity of the user making the synchronization request, or based upon the organization structure of the company. For instance, a company employee belonging to a certain organization in an affiliated structure of companies, may only be given access to data from its own company, or a certain limited number of other companies. In addition, if the organization structure is hierarchical, then employees of organizations lower down in the structure may have limited access to data from organizations higher up in the structure and vice versa. Similarly, the security filters can be based on security permissions afforded any given user or requester. Of course, a wide variety of other security filters can be used, and these are given for the sake of example only. Such a filter can be created, for instance, based on the identity of the user (which might be sent by the requestor) simply by accessing the security permissions (or security credentials) associated with a user, or the organization structure or both. Thus, the filter information may simply be the identity of the user or the user's security credentials or both.

Table 1 also shows that filtering can be based on a user's role. For instance, if a user or employee is an accountant that works in accounts receivable, the user may only be interested in obtaining a certain subset of data, whereas if the user is an accountant in auditing, the user may wish to access a different subset of data. The filters can be arranged in a wide variety of different ways, based on the various roles assumed by users or requesters, and based on the data needs for those specific roles. Of course, if the user works in multiple roles, the filter can be based on a collection of roles as well.

Table 1 also shows that the filters can be user-defined filters. In one embodiment, the user-defined filtering allows the user to define substantially any type of filtering mechanism to filter data in response to synchronization queries.

Other filters might include, by way of example only, the size of the returned data. A requester 602 may have only limited data storage space and may thus impose size criteria through the filtering mechanism.

In addition, the user may define filters based on application criteria. For instance, the user may only want clients that are not “on hold” as defined by the application. Or, the user may only want invoices that have not been paid.

Further, the requester may only want header or parent entities synchronized to its local cache (or other data store). The filtering can thus be performed on these criteria.

In all of these examples, the requester simply needs to provide enough information to the synchronization components or aggregation component so the filters can be discerned and applied to the returned data. This provides a great deal of flexibility.

It can thus be seen that the entity projection on the requestor 602 is created in the exact same way as described above, and even the specific properties to be synchronized can be defined in exactly the same way. However, the actual data synchronized to the local database of any specific requestor 602 for an entity projection will vary depending upon what types of filters are applied. Some of the filters may illustratively be mandatory, such as time stamp and security-based filters, and possibly organization within a structure while other filters will illustratively be user defined or will vary based on a given user, role, etc. Any combination of these filters can be used.

Aggregation component 614 simply receives the synchronization request 626 along with the filters to be applied to that request (or the information from which the filters can be derived) and retrieves from data store 616 the relevant information and provides it back to requester 602 as filtered data 640. This is indicated by block 642 in FIG. 6.

The synchronization component 613 (or another component) in requester 602 then applies the updated, filtered data 640 to its own local data store 606. This is indicated by block 644 in FIG. 6.

Although the present invention has been described with reference to particular embodiments, workers skilled in the art will recognize that changes may be made in form and detail without departing from the spirit and scope of the invention.

What is claimed is:

1. A method of filtering data synchronized to a requester and accessed through an entity on the requester, comprising:
sending from the requester to a data aggregating component a request for data along with at least one set of filter information that is indicative of at least one filter that comprises a security-based filter or a user-defined filter; and
receiving data filtered according to the at least one filter.

2. The method of claim 1 wherein the set of filter information comprises the filter.

3. The method of claim 1 wherein the set of filter information comprises information from which the filter is derived.

4. The method of claim 1 wherein the filter comprises the security-based filter that is based on a user or role's security permissions.

5. The method of claim 1 wherein the filter is based on a context within an organization structure of a user.

6. The method of claim 1 wherein the filter comprises the user-defined filter that is based on criteria set by a user.

7. The method of claim 1 wherein the filter comprises both the security-based filter and the user-defined filter.

8. The method of claim 1 wherein the filter comprises a temporal filter.

9. A filter mechanism for filtering data synchronized to a data store and accessed through an entity, comprising:
a requester having the data store and being configured to send a request for the data for the entity, the requester sending filter information indicative of a filter that comprises at least one of a security-based filter or a user-defined filter; and
a data aggregation component configured to receive the request and the filter information and to return filtered data, filtered based on the filter, the requester being further configured to receive the filtered data and apply it to the data store.

10. The filter mechanism of claim 9 wherein the filter comprises the user-defined filter that includes filter criteria set by a user.

11. The filter mechanism of claim 9 wherein the filter comprises both the user-defined filter and the security-based filter.

12. The filter mechanism of claim 9 wherein the filter comprises a role-based filter based on a role of a user or the requester.

13. The filter mechanism of claim 9 wherein the filter comprises an organization structure filter based on a context of a user or the requester in an organization structure.

14. A computer readable medium storing instructions which, when executed by a computer cause the computer to perform a method, comprising:
filtering data provided to a data store and accessed through an entity in a requester, by performing steps comprising:
sending from the requester to a data aggregating component a request for data along with filter information indicative of at least one filter that comprises a security-based filter or a user-defined filter; and
receiving, at the requester, filtered data that is filtered according to the filter.

15. The computer readable medium of claim 14 wherein filtering data further comprises:
applying the filtered data to the data store at the requester.

16. The computer readable medium of claim 14 wherein the filter comprises the security-based filter that is based on a user's security permissions.

17. The computer readable medium of claim 14 wherein filtering further comprises:
deriving the filter from the filter information at the aggregation component.

18. The computer readable medium of claim 14 wherein the filter comprises the security-based filter that is based on a context within an organization structure of a user or the requester.

19. The computer readable medium of claim 14 wherein the filter comprises the user-defined filter that is based on criteria set by a user.

20. The computer readable medium of claim 14 wherein the filter comprises both the security-based filter and the user-defined filter.
